(19) United States
(12) Patent Application Publication
(10) Pub. No.: US 2006/0208464 A1
(43) Pub. Date: Sep. 21, 2006

(54) Offset tandem suspension

(75) Inventors: John Raidel II, Springfield, MO (US); Bruce Barton, Springfield, MO (US); William Mattocks, Springfield, MO (US)

Correspondence Address: LATHROP & GAGE LC, 1845 S. NATIONAL, P.O. BOX 4288, SPRINGFIELD, MO, 65101, US

(73) Assignee: Ridewell Corporation

(21) Appl. No.: 11/377,863

(22) Filed: Mar. 16, 2006

Related U.S. Application Data
(60) Provisional application No. 60/662,287, filed on Mar. 16, 2005.

(51) Int. Cl. B60G 5/00; B62D 61/10

(52) U.S. Cl. 280/678; 180/24.01

(57) ABSTRACT

Provided is an offset tandem axle assembly system with a pair of walking beams mounted to suspension hangers so that about sixty percent of the overall beam length is oriented between the hanger pivot and a non-driven axle and about forty percent of the overall beam length is oriented between the hanger pivot and the driven axle. A torque rod pivotally connects the non-driven axle to each suspension beam. A single resilient air spring mounted between the non-driven axle and each suspension beam dampens loading and rebound for both the driven and non-driven axles. The non-driven axle can be either a tag axle or a push axle and may be self steering.

### RELATED APPLICATION

This application claims priority of the U.S. patent application Ser. No. 60/662,287 filed on Mar. 16, 2005, entitled “Offset Tandem Suspension,” the disclosure of which is incorporated herein by reference.

### BACKGROUND

The present invention relates to a single point tandem vehicle suspension mounting a pair of air suspended walking beams. More particularly, the invention is a tandem suspension for split axles with either a pusher or tag non-driven axle paired with a drive axle and wherein the beam length between the suspension hanger and the non-driven axle is greater than 50% of the overall beam length. The beam is positioned offset from the pivot of the suspension hanger depending from the chassis so that approximately 60% of the load distribution is placed on the drive axle and 40% of the load distribution is to the non-drive tag or pusher axle.

Vehicle suspension systems include a wide variety of configurations and structures. It is common in the large truck industry to provide dual or tandem axle configurations to support heavy loads. Often, a driven or powered axle is used in combination with a non-driven axle. The non-driven axle may be used as a tag axle where it is positioned rearward the drive axle. The non-drive axle may be also be placed in front of the drive axle as a pusher. Both pusher and tag non-driven axles may be non-steerable, power steerable or self steering.

Tandem axle suspensions often include separate hanger brackets or other mounting apparatus for each of the two axles. It is also known to connect the two axles with a pair of beams, sometimes called walking beams, and to pivotally connect the beams to the vehicle chassis with a single hanger mounted to the beams midway between the two axles.

The configuration of the related art, wherein the suspension beams are mounted intermediate the driven and non-driven axles results in an inefficient application of downward force disbursed equally to the driven and non-driven axle. It is desirable and beneficial to place a greater load on the driven axle than the non-driven axle, particularly in a self-steering tag axle orientation. The present invention allows the greater percentage of the downward loading force to be distributed to the driven axle than the non-driven axle which has numerous benefits.

One benefit to the configuration of the present invention is that the loading and road inputs can be dampened and equalized for both axles utilizing a single air spring per beam. The offset beam mounting configuration also creates increased articulation for both the driven and non-driven axles. For example, at a ten inch mounting height, the drive axle can achieve three inches up/down articulation while the tag axle can achieve four and one half inches up/down articulation. Because of good articulation at both axle positions, traction at the drive axle is substantially enhanced over a traditional tandem suspension where the loading is equalized between the axles by a mid-beam attachment point. Because of the beam offset, a tag self steer can reduce tire scrub and reduce the overall turning radius of the vehicle. Tire scrub can also be reduced at the tag self steering axle with an integrated reverse caster. The present invention also significantly decreases the overall weight of a traditional tandem drive axle by reducing the necessary overall geometry of the beams, and eliminating one pair of air springs.

### SUMMARY

The offset tandem axle assembly system of the present invention comprises a pair of suspension beams positioned on opposite sides of a vehicle chassis. Each assembly includes a downward depending hanger rigidly fixed to a chassis rail. A suspension beam, commonly called a walking beam, having opposed ends is pivotally connected within the hanger bracket. A drive axle is attached to the first end of each suspension beam and a non-driven axle is provided substantially adjacent to the second end of the suspension beam. As shown in the accompanying drawings, each suspension beam is pivotally attached within the hanger bracket with approximately 40% of the overall suspension beam length oriented between the hanger pivot and the driven axle and approximately 60% of the overall beam length oriented the hanger pivot and the non-driven axle. The offset geometry is preferably a 60/40 orientation between the hanger bracket and the driven axle and non-driven axle. The non-driven axle can be either a tag axle or a pusher axle and may be self steering.

A resilient air spring is mounted between the second end of the suspension beam and the non-driven axle. A short torque rod pivotally connects the non-driven axle, substantially adjacent each resilient air spring, to each suspension beam at a point near the hanger pivot. Generally, torque rod mounts will be provided on both the suspension beam and the non-driven axle. In the first embodiment of the invention, each suspension beam has offset geometry such that the driven axle is mounted on top of the first end of the suspension beam and the non-driven axle is mounted below the second end of the suspension beam, with an air spring between the axle and beam end.

### BRIEF DESCRIPTION OF THE DRAWINGS

FIG. 1 is a side view of an axle assembly showing offset beam attachment according to an embodiment;

FIG. 2 is a perspective view showing the offset beam geometry and suspension assembly according to an embodiment;

FIG. 3 is a bottom view of a suspension assembly, according to an embodiment.

FIG. 4 is a perspective view of a non-steer tag or pusher axle, according to an embodiment.

### DETAILED DESCRIPTION

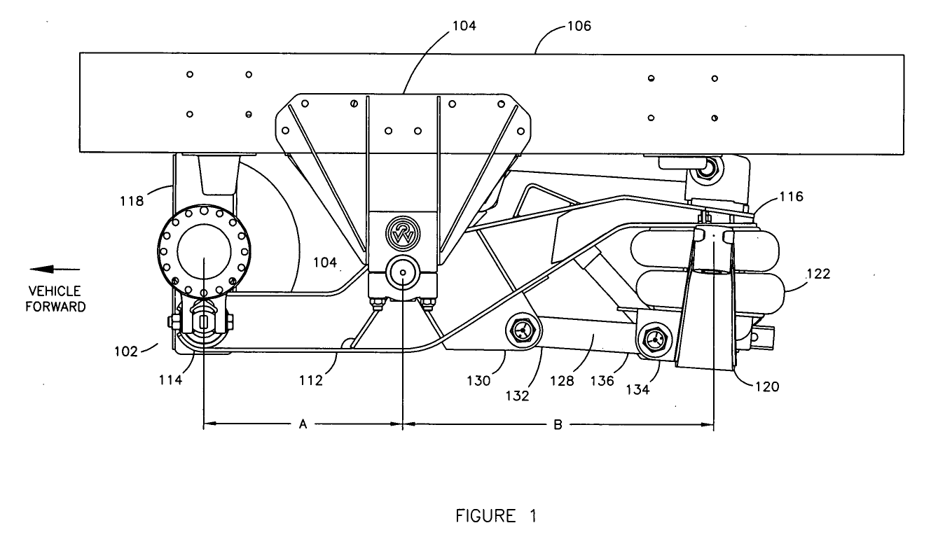

Referring now generally to FIG. 1, a tandem axle vehicle suspension 102 is shown. It is understood that the suspension system includes two identical assemblies, one positioned on either side of the vehicle. The suspension system 102 comprises a pair of suspension hanger brackets 104 depending from spaced apart vehicle rails 106. Each hanger 104 further has opposed sides and mounting bores for the receipt and pivotal retention of a suspension beam 112. The suspension beams 112 have opposed ends 114 and 116 and are positioned within the hanger bracket 104 and pivotally mounted therein with suitable fasteners. Each suspension beam 112 has a forward or first end 114 and a rearward or second end 116. In a first embodiment of the invention, the forward end 114 of each suspension beam 112 is attached to a drive axle 118. The rearward end 116 of each suspension beam 112 is oriented generally above or over a non-driven axle 120 with a resilient air spring 122 positioned between the suspension beam 112 and the uppermost axle surface.

The overall geometry of each suspension beam 112 is that of an offset lever wherein the forward end is oriented generally downward away from the vehicle rails 106 such that the drive axle 118 can be positioned between the suspension beam 112 and the vehicle chassis. The rearward end 116 of each suspension beam 112 is canted generally upward in orientation from the forward end 114 so that it overlies the non-driven axle 120.

As best shown in FIG. 1, the dimension or Length A between the suspension hanger 104 pivot and the driven axle 118 attached near the first end 114 of the suspension beam 112 is less than 50% and preferably approximately 40% of the overall suspension beam length. The dimension or Length B between the suspension hanger 104 pivot and the non-drive axle 120 attached near the second end 116 of the suspension beam 112 is greater than 50% and preferably approximately 60% of the overall suspension beam length. This orientation imparts approximately 60% of the downward load on the drive axle 118 and 40% of the downward load on the non-driven axle 120.

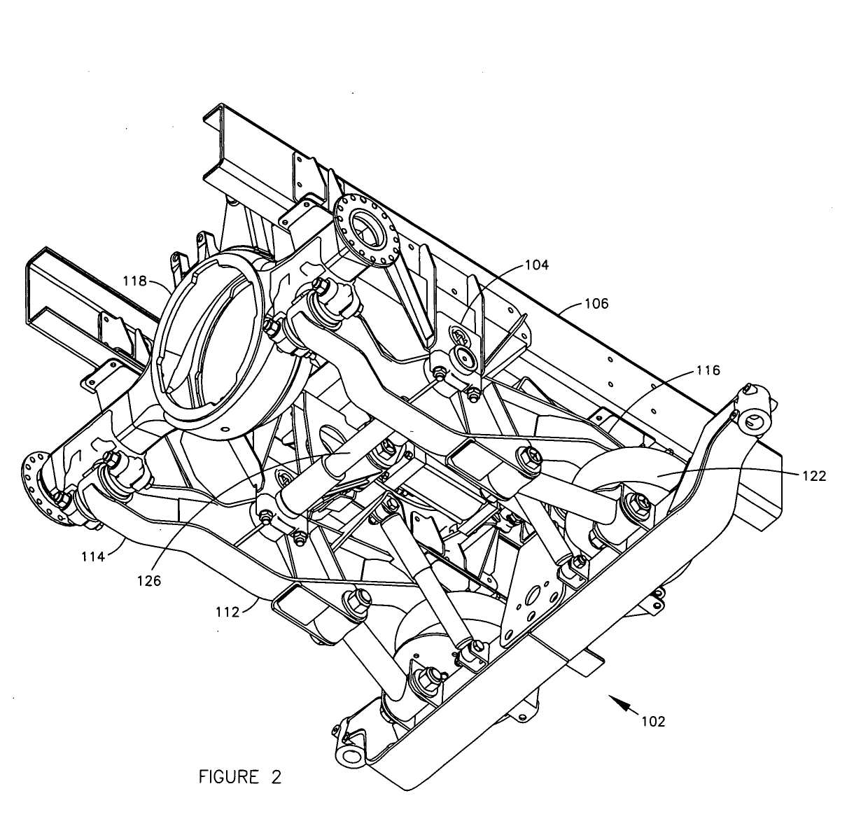

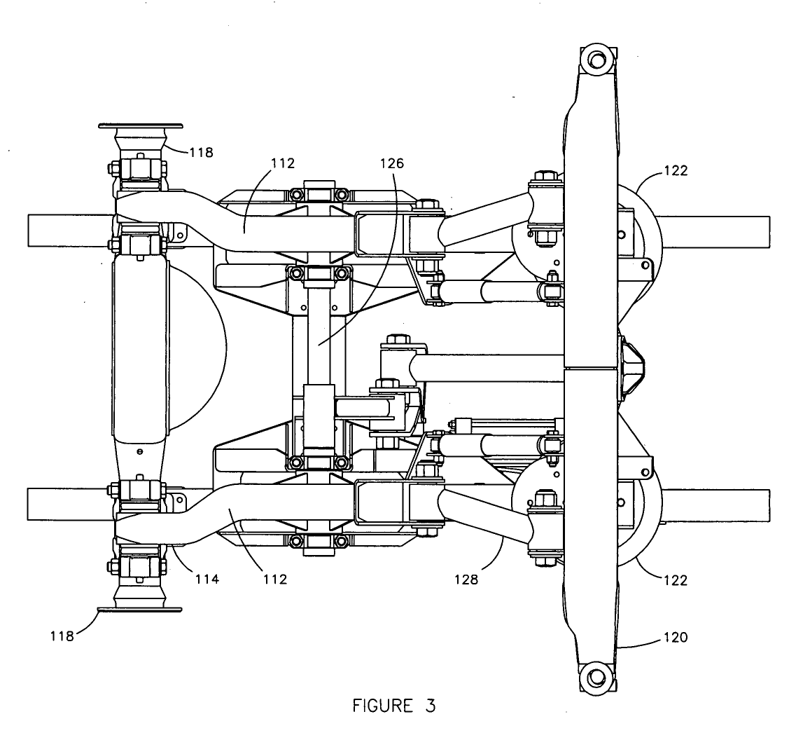

In FIG. 1, the directional arrow represents the general front of the vehicle assuming a forward moving direction. Accordingly, the driven axle 118 is positioned forward of the non-driven axle 120 or tag axle. It is to be understood that the orientation of the driven axle 118 and non-driven axle 120 can be reversed. For example, in FIG. 3, the tag axle 120 can be made into a pusher axle by simply turning the suspension 180° within the suspension hanger brackets 104. Clearly, the driven axle 118 will also have to be reversed and the drive shaft refitted. However, the configuration and overall geometry of the present invention allows for an easy conversion between a push axle and a tag axle set up. As best shown in FIGS. 2 and 3, at least one stiffening rod 126 may be positioned between the spaced apart suspension beams 112 to reduce or limit side loading. It is understood that multiple stiffening rods may be used at any variety of locations and orientations to stiffen or stabilize the suspension system depending on specific applications and needs.

In the preferred embodiment of the inventive device, the mounting orientation of the beams 112 with respect to the hanger brackets 104 is critical. It is preferred that 60% of the overall suspension beam length be oriented between the suspension hanger pivot 104 and the non-driven axle 120 while 40% of the overall suspension beam length is oriented generally between the suspension hanger 104 pivot and the forward end 114 of the suspension beam 112. Because less of the overall beam length is between the suspension hanger pivot 104 and the driven axle 118, more of the downward load force is imparted to the driven axle 118. This orientation is best seen in FIGS. 1 and 2. It is to be understood that the overall orientation of the axles can be reversed from a rear or trailing axle application to a pusher application with the driven axle generally rearward or behind the non-driven axle on the vehicle. In this orientation, the geometry of the suspension beams 112 remains the same with approximately 40% of the overall beam length generally between the hanger pivot 104 and the driven axle 118 and 60% of the overall beam length between the non-driven axle 120 and the hanger pivot 104. It is understood that minor deviations in the mounting geometry can be made without departing from the scope of this invention.

As best shown in FIG. 1, a torque rod 128 is pivotally mounted between the non-driven axle 120 and the suspension beam 112, preferably below the hanger 104 pivot. A first bracket 130 may be mounted to a lower face of the suspension beam 112 substantially near the hanger bracket 104 for mounting a first end 132 of the torque rod 128. A second bracket 134 is generally mounted to a face of the non-driven axle 120 to receive and pivotally retain the second end 136 of the torque rod 128.

It is preferred that a pivot bushing is mounted at both the first end 132 and second end 136 of the torque rod 128 within the first and second mounting brackets 130, 134 respectively. The torque rod ends 132, 136 may generally be retained within the brackets 130, 136 by a nut and bolt fastener, or similar fastening mechanism.

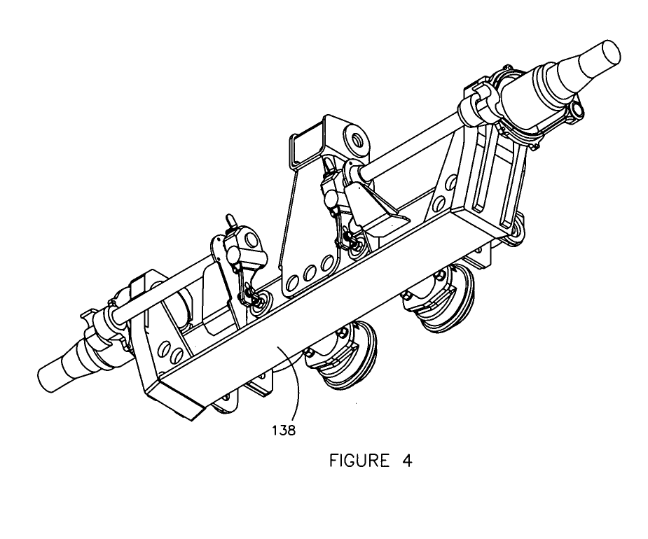

Referring now to FIG. 4, a non-steer, non-driven axle 138 is shown which can be substituted for the self steer, non-driven axle 120 described above. Again, the distance between the non-steer axle 138 and the hanger bracket 104 is more than 50% of the overall beam length and preferably approximately 60% of the overall beam length. It is to be understood that any variety of known axle combinations can be utilized in the inventive configuration and structure. In particular any combination of driven and non- driven axles as well as self-steer, power steer, non-steer axles can be used within the spirit and scope of this invention.

In this preferred embodiment of the invention, the vertical load imparted by the vehicle is unequally applied between the driven axle 118 and non-driven axle 120 due to the offset orientation of the suspension beams 112 within the hanger brackets 104. The suspension beam 112 geometry accommodates the 60/40 offset mounting orientation with one resilient air bag 122 per suspension beam 112 which effectively cushions both the driven and non-driven axles 118, 120.

Changes may be made in the above methods, devices and structures without departing from the scope hereof. It should be noted that the matter contained in the above description and/or shown in the accompanying drawings should be interpreted as illustrative and not in a limiting sense. The following claims are intended to cover all generic and specific features described herein, as well as all statements of the scope of the best method, device and structure, which, as a matter of language, might be said to fall therebetween.

What is claimed is:

1. An offset tandem suspension system for a vehicle, comprising:
a pair of suspension hanger brackets depending from a vehicle frame;
a pair of walking beams, each pivotally connected within one of the hanger brackets;
a driven axle secured at a first end of the suspension beams;
a non-driven axle supported at a second end of the suspension beams;
at least one resilient airbag spring disposed between the non-driven axle and the second end of each suspension beam;
and wherein the length of the suspension beam between the hanger bracket connection to the suspension beam and the drive axle is less than 50% of the overall suspension beam length.

2. The offset tandem suspension system of claim 1 further comprising: at least one torque rod pivotally connecting the non-driven axle and the suspension beam;

3. The offset tandem suspension system of claim 1 wherein the distance between the hanger bracket connection to the suspension beam is approximately 40% of the overall suspension beam length.

4. The offset tandem suspension system of claim 1 further comprising at least one stiffening rod mounted between the hanger brackets.

5. The offset tandem suspension system of claim 1 further comprising at least one stiffening rod mounted between the suspension beams.

6. The offset tandem suspension system of claim 1 wherein the non-driven axle is a self-steering axle.

7. The offset tandem suspension system of claim 1 wherein the non-driven axle is a fixed tag axle.

8. The offset tandem suspension system of claim 1 wherein the non-driven axle is a fixed push axle.

9. An offset tandem suspension for a vehicle, comprising:
a pair of suspension beams each beam having a first end connected to a drive axle and a second spaced-apart end; a torque rod pivotally connecting each suspension beam to a spaced-apart non-driven axle; an air spring interposed the second end of each suspension beam and the non-driven axle; a pair of suspension hanger brackets depending downward from a vehicle chassis to which each suspension beam is pivotally attached with approximately 60% of the overall suspension beam length positioned between the hanger bracket and the non-driven axle.

10. An offset tandem axle vehicle suspension, comprising: a pair of suspension beams, each beam having a first end and spaced apart second end and a midpoint intermediate thereto; said first end of each suspension beam having pivotally attached thereto a driven axle, and the second end of said suspension beam connecting to a resilient air spring overlying a non-driven axle, a first bracket mounted substantially near the midpoint of the suspension beam for pivotally connecting a torque rod to the non-driven axle, and wherein the suspension beam is pivotally connected to a suspension hanger bracket depending from a vehicle chassis between the driven axle and the geometric midpoint of the suspension beam such that less than 50% of the suspension beam length is oriented between the hanger bracket and the driven axle.

11. The offset tandem axle suspension of claim 10 wherein the distance between the hanger bracket and the driven axle is 40% of the overall length of the suspension beam.
